(19) United States
(12) Patent Application Publication
(10) Pub. No.: US 2008/0090929 A1
(43) Pub. Date: Apr. 17, 2008

(54) Ink compositions and methods of use thereof

(75) Inventors: Daniel A. Wilson, Cincinnati, OH (US); Sara E. Edison, Newport, KY (US); Sudhakar Madhusoodhanan, Cincinnati, OH (US); Devdatt S. Nagvekar, Hamilton, OH (US); Matthew M. Ellison, Mason, OH (US)

Correspondence Address: HEXION SPECIALTY CHEMICALS, INC., 1600 SMITH STREET, P.O. BOX 4500, HOUSTON, TX, 77210-4500, US

(73) Assignee: Hexion Specialty Chemicals, Inc.

(21) Appl. No.: 11/974,325

(22) Filed: Oct. 12, 2007

Related U.S. Application Data
(60) Provisional application No. 60/829,431, filed on Oct. 13, 2006.

(51) Int. Cl. C09D 11/10

(52) U.S. Cl. 522/75; 522/114; 522/116

(57) ABSTRACT

Disclosed herein are rapid radiation curable ink compositions that can cure at speeds that are greater than the speeds at which other commercially available ink compositions cure. The rapidly curing ink compositions advantageously display an increased cure speed, improved adhesion and solvent resistance when compared with other commercially available compositions. The ink compositions of the invention are substantially free of solvent, and include an ethylenically unsaturated hyperbranched oligomer having an average functionality of at least 6 per oligomer, a difunctional ethylenically unsaturated compound, and a photoinitiator. The ink compositions optionally include a surfactant and/or a vinyl amide monomer.

### RELATED APPLICATION DATA

This application claims the benefit of U.S. Provisional Application Ser. No. 60/829,431 filed Oct. 13, 2006, the entire contents of which are hereby incorporated by reference.

### FIELD OF THE INVENTION

The present invention relates to rapid radiation curable ink compositions and to methods of their manufacture and to methods of use thereof. The compositions of the invention exhibit rapid cure, are substantially free of solvent, and comprise an ethylenically unsaturated hyperbranched oligomer having an average functionality of at least 6 per oligomer, a difunctional ethylenically unsaturated compound, and a photoinitiator. The compositions optionally include a surfactant and/or a vinyl amide monomer.

### BACKGROUND OF THE INVENTION

Inkjet inks curable by radiation, particularly ultraviolet (UV) radiation, are known. Such inks are difficult to formulate because the inks must satisfy numerous criteria affecting performance and stability. For example, the inks must possess low viscosity, an appropriate level of surface tension, low volatility, low smear, high image quality (especially at high print speeds), and adhesion to a variety of substrate materials. Stability of the inks is also important, including storage stability, stability at high shear rates, stability at high temperatures, and stability at the extreme conditions inside a print head, e.g. an impulse printhead.

A desirable feature in inkjet inks is their ability to cure rapidly and prevent ink transfer. Oxygen inhibition at the air interface and specific pigment absorptions which interfere with the absorption by key photoinitiators in the ink composition both can limit the cure rate of UV inkjet inks that cure via a free-radical mechanism. For example, in a 4-color (cyan, magenta, yellow, black) set of inks, the black ink cure speed can severely limit the overall printing speed for the printer because of the broad UV absorption of carbon black pigments. In white curing processes, the usual presence of titanium dioxide blocks all but the longer-wavelength UV emitted from standard commercial curing lamp technology. In inkjet printing processes, materials are deposited on substrates in very thin sections where shorter wavelengths are needed to accomplish appropriate cure due to oxygen inhibition. Undercuring of acrylate-containing inkjet inks can lead to unreacted monomeric components that are easily transferred in roll-to-roll applications or stacking and packaging of printed materials. In order to increase throughput in UV inkjet printing processes using free radically reactive raw materials, there is a need for inks that develop tack-free properties at a faster rate than currently available inks.

Recent advances in lamp technology have resulted in lower-power “pinning” lamps being used in high-speed radiation-curable inkjet printing processes. One example of such a lamp system is the OmniCure Series 2000 system available from EXFO Life Science & Industrial Division, Mississauga, Ontario, Canada. Another type of lower-powered pinning lamp would be based upon LED or semi-conductor light matrix technology. An example of LED-based systems is the LED Cure-All series from Con-Trol-Cure, Inc. An example of the semi-conductor light matrix technology is the RX Firefly from Phoseon Technology. The function of these lamps is to freeze the droplets in place on the substrate in a very short time frame (often <0.5 seconds) after jetting in order to enhance image quality. Commercially available UV inkjet inks are not typically reactive enough to be utilized in these types of processes and require additional curing speed to be effectively immobilized in this intermediate stage prior to being fully cured with a higher-powered, traditional UV lamp.

### SUMMARY OF THE INVENTION

In one embodiment, there is provided a rapid radiation curable ink composition which includes about 1 to about 30 weight percent (wt. %) of an ethylenically unsaturated hyperbranched oligomer having an average functionality of at least 6 per oligomer, about 15 to about 75 wt. % of a difunctional ethylenically unsaturated compound, optionally about 0.025 to about 1 wt. % of a surfactant, about 0.1 to about 25 wt. % of a colorant composition and a photoinitiator, where the weight percents are based upon the total weight of the ink composition, and where the ink composition is substantially free of solvent.

In another embodiment, there is provided a rapid radiation curable white ink composition which includes about 5 to about 25 wt. % of an ethylenically unsaturated hyperbranched oligomer having an average functionality of at least 6 per oligomer, about 15 to about 80 wt. % of a difunctional ethylenically unsaturated compound, an amine synergist, optionally about 0.001 to about 1 wt. % of a surfactant, about 0.1 to about 25 wt. % of a colorant composition and a photoinitiator, where the weight percents are based upon the total weight of the ink composition, and where the ink composition is substantially free of solvent.

In another embodiment, there is provided a process for preparing a printed article, which includes contacting a substrate with the cured rapid radiation curable ink composition of the invention.

In another embodiment, there is provided an article of manufacture, which includes a substrate and the cured rapid radiation curable ink composition of the invention.

### DETAILED DESCRIPTION

The use of the terms “a” and “an” and “the” and similar references in the context of describing the invention (especially in the context of the following claims) are to be construed to cover both the singular and the plural, unless otherwise indicated herein or clearly contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

Disclosed herein are rapid radiation curable ink compositions that can cure at speeds that are greater than the speeds at which other commercially available ink compositions cure. The rapidly curing ink compositions advantageously display an increased cure speed, improved adhesion and solvent resistance as compared with other commercially available compositions. In one embodiment, the rapidly curing ink composition advantageously comprises a hyperbranched reactive oligomer having a functionality of at least 6 and optionally a vinyl amide monomer. This combination of ethylenically unsaturated monomers and hyperbranched unsaturated oligomers in the presence of photoinitiators known in the art to give appropriate cure response produces inks that cure to give transfer-free films after a UV exposure of a radiant energy density of about 65 mJ/cm² for process colors (cyan, magenta, yellow, and black, also denoted as CMYK) and about 50 mJ/cm² for white inks employing mercury vapor (CMYK inks) or iron-doped (white inks) bulbs. The cured films also exhibit much higher solvent resistance than other comparative commercially available compositions.

As mentioned previously, lower-powered lamps can be employed on printers for the purpose of immobilizing droplets in very short timeframes after jetting and impingement on the substrate. Typical radiant energy densities or doses employed in these processes are less than about 20 mJ/cm², as measured via an International Light IL390C radiometer at a distance of 1 to 2 millimeter (mm) from lamp to radiometer. Inks of the current invention have demonstrated acceptable pinning activity at doses within the 10 to 20 mJ/cm² range.

In one embodiment, when the optional vinyl monomer is not included in the rapid radiation curable ink compositions of the invention, the inks display a viscosity increase of less than or equal to about 15% (when viscosity is measured at 25° C.) after aging the inks at 60° C. for 4 weeks.

The hyperbranched reactive oligomers used in the rapid radiation curable ink compositions of the invention are similar to dendrimers, and have structures that are densely branched, approximately spherical in shape and have a large number of end groups. Suitable hyperbranched ethylenically unsaturated oligomers suitable for use in the ink compositions are those prepared from, for example, hydroxy functional hyperbranched polyols reacted to form polymers with, for example, residual hydroxyl, carboxylic acid, or carboxylic acid ester functionalities. These functional polymers are then reacted with hydroxyl-functional or acid-functional monomers containing ethylenic unsaturation such as, 2-hydroxyethyl acrylate or acrylic acid to form acrylate esters. The number of ethylenic unsaturations present on the hyperbranched oligomers is greater than about 6. Exemplary hyperbranched oligomers include polyester acrylate oligomers commercially available from Sartomer, such as CN2300, CN2301, CN2302, CN2303, and CN2304. Other examples include polyester acrylate oligomers BDE-1025 and BDE-1029 available from Bomar Specialties.

In one embodiment, the ethylenically unsaturated hyperbranched oligomer used in the rapid radiation curable ink compositions of the invention generally has a functionality of at least about 6 to about 25, specifically about 12 to about 20, more specifically about 14 to about 18 per oligomer. In another embodiment, the ethylenically unsaturated hyperbranched oligomer used in the ink compositions generally has a functionality of about 6 to about 15, specifically about 6 to about 12, more specifically about 6 to about 9 per oligomer.

The amount of ethylenically unsaturated hyperbranched oligomer is about 1 to about 30 wt. %, specifically about 1.5 to about 30 wt. %, and more specifically about 5 to about 30 wt. %, wherein the weight percents are based on the total weight of the rapid radiation curable ink compositions of the invention. An exemplary amount of the ethylenically unsaturated hyperbranched oligomer is about 15 to about 30 wt. %, wherein the weight percents are based on the total weight of the rapid radiation curable ink compositions of the invention.

When utilized, the vinyl amide monomer is a mono-ethylenically unsaturated monomer having at least one amide group. Examples of suitable vinyl amide monomers are N-vinyl pyrrolidone, N-vinyl-2-caprolactam, N-vinyl formamide, N-vinylacetamide, N-vinyl-N-methylacetamide, N-alkyl-N-vinylacetamide such as, for example, N-methyl-N-vinylacetamide, or the like, or a combination comprising at least one of the foregoing vinyl amide monomers. An exemplary commercially available vinyl amide monomer is V-CAP® commercially available from BASF Corporation or International Specialty Products.

The amount of vinyl amide monomer, when utilized, is about 0.1 to about 20 wt. %, specifically about 12 to about 18 wt. %, more specifically about 14 to about 17 wt. %, wherein the weight percents are based on the total weight of the rapid radiation curable ink compositions of the invention.

In one embodiment, in addition to the vinyl amide monomer and the hyperbranched reactive oligomers, the rapid radiation curable ink compositions can comprise ethylenically unsaturated compounds, particularly materials containing (meth)acrylate groups. The ethylenically unsaturated compounds may be monofunctional, difunctional, trifunctional or tetrafunctional.

Appropriate selection of an additional optional monofunctional ethylenically unsaturated compound, distinguished from the vinyl amide monomer described above, can provide a desired lower viscosity in the resulting ink. Monofunctional ethylenically unsaturated materials for use in the radiation curable inks include, for example, (meth)acrylates of straight chain, branched chain, or cyclic alkyl or aromatic alcohols, including polyether alcohols. Specific examples include acrylates of alcohols having more than four carbon atoms, for example lauryl acrylate and stearyl acrylate; (meth)acrylates of polyether alcohols, such as 2-(2-ethoxyethoxy)ethyl acrylate; (meth)acrylates, of heterocyclic alcohols, optionally containing an aliphatic linking group between the (meth)acrylate and the heterocycle, such as tetrahydrofuran acrylate, oxetane acrylate, isobornyl acrylate, cyclopentadiene acrylate, trimethylcyclohexane acrylate, tert-butylcyclohexane acrylate, of aromatic alcohols, such as 2-phenoxyethyl acrylate and the like. Combinations comprising at least one of the foregoing can be used. In one embodiment the ink compositions of the invention contains a monofunctional ethylenically unsaturated compound in an amount of between about 0 wt. % and about 10 wt. %, preferably less then 5 wt. %, and preferably between about 1 wt. % and 5 wt. % based upon the total weight of the ink.

In another embodiment, in addition to the vinyl amide monomer and the hyperbranched reactive oligomers, the ink composition can comprise ethylenically unsaturated materials, particularly materials containing (meth)acrylate groups.

Multifunctional compounds are used and selected so as to provide the desired viscosity and crosslink density. Suitable difunctional ethylenically unsaturated compounds include, for example, di(meth)acrylates of diols and polyetherdiols, including glycols and polyglycols, such as propylene glycol and polypropylene glycols. Repeating units of glycols including di-, tri- and higher glycols can be used. Other suitable di(meth)acrylates include the di(meth)acrylate of 1,4-butanediol (e.g., SR 213), 1,3-butanediol, neopentylglycol, propoxylated neopentyl glycol (e.g., SR 9003, a diacrylate of a propoxylated neopentyl glycol), diethylene glycol (e.g., SR 230), hexanediol (e.g., SR 238), dipropylene glycol (e.g., SR 508), tripropylene glycol (e.g., SR 306), triethylene glycol (e.g., SR 272), polyethylene glycol (e.g., SR 259), alkoxylated hexane diols (e.g., CD 560 and CD 564), neopentylglycol (e.g., SR 247), tetraethylene glycol (SR268) and the like, and di(meth)acrylates available under the trade name SR 9209 (an alkoxylated aliphatic diacrylate). Product names with the “SR” and “CD” designations, referenced herein, are commercially available from Sartomer. Divinyl and/or diallyl compounds may also be used. Combinations comprising at least one of the foregoing difunctional compounds can be used.

Exemplary suitable trifunctional ethylenically unsaturated compounds include (meth)acrylate esters of triols, for example glycerol, trimethylol propane, pentaerythritol, neopentyl alcohol, and the like. Alkoxylated (meth)acrylates can also be used, for example propoxylated and ethoxylated (meth)acrylates such as ethoxylated trimethylol propane tri(meth)acrylates, propoxylated glyceryl tri(meth)acrylates, propoxylated pentaerythritol tri(meth)acrylates, tris(2-hydroxyethyl)isocyanurate tri(meth)acrylate, and the trifunctional acrylate ester available from Sartomer under the trade name SR 9012. Combinations comprising at least one of the foregoing trifunctional compounds can be used. In another embodiment the ink compositions of the invention are free of the trifunctional ethylenically unsaturated compounds listed in this paragraph.

Suitable tetrafunctional ethylenically unsaturated compounds include, for example alkoxylated (meth)acrylates obtained from tetraols, such as ethoxylated pentaerythritol tetra(meth)acrylates, and the like.

In one embodiment the ink compositions of the invention are free of non-hyperbranched ethylenically unsaturated components with a functionality of three or greater. In another embodiment the ink compositions of the invention contains a total amount of non-hyperbranched ethylenically unsaturated components, with a functionality of three or greater, and of the ethylenically unsaturated hyperbranched oligomer, between about 1 and about 30 wt. %, based upon the total weight of the ink.

An exemplary difunctional ethylenically unsaturated compound used in the rapid radiation curable ink compositions of the invention is 1,6 hexanediol acrylate, commercially available as SR-238 from Sartomer.

In one embodiment, in the rapid radiation curable ink compositions, the difunctional ethylenically unsaturated compound is present in an amount of about 15 to about 75 wt. %, specifically about 35 to about 45 wt. %, based on the total weight of the rapid radiation curable ink compositions. In another embodiment, in the ink compositions, the difunctional ethylenically unsaturated compound is present in an amount of about 15 to about 80 wt. %, specifically about 45 to about 70 wt. %, and yet more specifically about 48 to about 65 wt. %, based on the total weight of the ink compositions.

The types and relative amounts of the ethylenically unsaturated compounds are preferably selected so as to provide the desired viscosity, adhesion to the substrate, and wettability of the substrate to be printed. The compounds may further be selected so as to provide other desired properties to the inkjet ink, for example stability, effective pigment dispersion, pigment wetting, miscibility with one another, appropriate wettability for the print head, jettability, adhesion, fast cure speed, and the like. For example, acrylate compounds tend to react faster than methacrylate compounds. The inkjet ink compounds are further selected so as to provide adequate stability, specifically thermal, hydrolytic, and rheological stability during inkjetting, and storage stability. The compounds can also be selected so as to provide a cured material that is lightfast and resistant to yellowing when aged.

In particular, the materials are selected so as to provide a viscosity suitable for inkjetting after the rapid radiation curable ink compositions have been formulated with the pigment dispersion, initiator, and any other additives. The viscosity of the ink has an effect on the priming of the inkjet print head, as well as jetting reliability. Good priming of the print head (ease of loading the print head with ink) in turn allows for good droplet formation. In one embodiment, the viscosity of the respective ink compositions is less than 60 centipoise, specifically less than 50 centipoise, and more specifically less than 40 centipoises, measured at 25° C. Inkjet inks suitable for use with current impulse printheads have a viscosity greater than about 1 centipoise.

The viscosity of the rapid radiation curable ink compositions is adjusted by the optional use of an appropriate amount of a specific type of a low viscosity monomer or polymer, an aliphatic alkyleneoxide oligomer having at least one ethylenically unsaturated group, for example a (meth)acrylate, allyl, or vinyl, particularly a vinylether group, and the like, as well as combinations comprising at least one of the foregoing groups. Monomers having a combination of a (meth)acrylate and a vinylether group are especially useful for decreasing the viscosity of curable compositions that contain high-viscosity materials such as urethane acrylates. The low-viscosity monomer may have a viscosity of about 1 to about 20 centipoise (cP), specifically about 2 to about 17 cP, more specifically about 5 to about 15 cP, measured at a temperature of 25° C. Exemplary low viscosity monomers include but are not limited to 2-(2-vinylethoxy)ethyl(meth)acrylate, 2-(2-vinylethoxy)-2-propyl (meth)acrylate, 2-(2-vinylethoxy)-3-propyl (meth)acrylate, 2-(2-vinylethoxy)-2-butyl (meth)acrylate, 2-(2-vinylethoxy)-4-butyl (meth)acrylate, 2-(2-allylethoxy)ethyl (meth)acrylate, 2-(2-allylethoxy)-2-propyl (meth)acrylate, 2-(2-allylethoxy)-3-propyl (meth)acrylate, 2-(2-allylethoxy)-2-butyl (meth)acrylate, 2-(2-allylethoxy)-4-butyl (meth)acrylate, 2-(2-vinylpropoxy)ethyl (meth)acrylate, 2-(2-vinylpropoxy)2-propyl (meth)acrylate, 2-(2-vinylpropoxy)-3-propyl (meth)acrylate, 2-(3-vinylpropoxy)ethyl (meth)acrylate, 2-(3-vinylpropoxy)-2-propyl (meth)acrylate, 2-(3-vinylpropoxy)-3-propyl (meth)acrylate, and combinations comprising at least one of the foregoing.

When used, the low-viscosity monomer can be present in an amount of about 1 to about 80 wt. %, specifically about 5 to about 75 wt. %, and more specifically about 10 to about 70 wt. % of the weight of the rapid radiation curable ink compositions.

The rapid radiation curable ink compositions may also optionally comprise a surfactant for controlling the surface tension of the ink composition. The surfactant also improves substrate wetting and surface slip in the ink compositions. An example of a suitable surfactant for use in the ink compositions is a polyether polysiloxane. An example of a suitable commercially available surfactant is BYK 3770 available from Byk Chemie. Other examples include BYK 3500, 3501, 3510 and TEGORAD 2200N, 2300 available from Degussa.

The surfactant may be added to the rapid radiation curable ink compositions in an amount of about 0.025 to about 1 wt. %, specifically about 0.050 to about 0.75 wt. %, and more specifically about 0.075 to about 0.5 wt. % based upon the total weight of the respective compositions.

In another embodiment, the rapid radiation curable ink compositions may be formulated to have improved cure in the presence of oxygen, even when jetted at thin application levels.

One approach to reducing the oxygen inhibition of the inkjet ink is the optional addition of a multifunctional thiol compound to the ink compositions. Inks containing the multifunctional thiol compound can be cured even when jetted in very thin amounts as the thiol compound can react with ethylenic unsaturated functionalities without inhibition by oxygen. Use of these thiol compounds, at thin application levels, allows for an enhanced rate of surface cure.

Inks containing the multifunctional thiol compound can be cured even when jetted in very thin amounts.

The multifunctional thiol compounds comprise two or more thiol groups per molecule, and can be monomeric or oligomeric. Combinations of one or more multifunctional thiol compounds can be used in the curable compositions. Exemplary multifunctional thiol monomers include alkyl thiol compounds such as 1,2-dimercaptoethane, 1,6-dimercaptohexane, neopentanetetrathiol, and the like, pentaerythritol tetra(3-mercapto propionate), 2,2-bis(mercaptomethyl)-1,3-propanedithiol, and the like, aryl thiol compounds such as 4-ethylbenzene-1,3-dithiol, 1,3-diphenylpropane-2,2-dithiol, 4,5-dimethylbenzene-1,3-dithiol, 1,3,5-benzenetrithiol, glycol dimercaptoacetate, glycol dimercaptopropionate, pentaerythritol tetrathioglycolate, trimethylolpropane trithioglycolate, and the like. Also suitable are polyethylene glycol dimercaptoacetate oligomers.

Suitable oligomeric multifunctional thiols include, for example, (mercaptoalkyl)alkylsiloxane homopolymers or copolymers, such as (mercaptopropyl)methylsiloxane homopolymers or copolymers (e.g., SMS-992 available from Gelest, Inc.), mercapto-terminated oligomers, mercapto-containing polysilsesquioxanes, and the like. Examples of polyorganosiloxanes having alkylthiol groups can be found in U.S. Pat. Nos. 3,445,419, 4,284,539, and 4,289,867, which is incorporated herein by reference. Examples of other oligomeric multifunctional thiols can be found in U.S. Pat. No. 3,661,744.

In one embodiment, when utilized, the thiol can be present in the ink compositions in an amount of up to about 15 wt. %, specifically about 1 to about 12 wt. %, more specifically about 3 to about 10 wt. %, yet more specifically about 5 to about 8 wt. %, based on the total weight of the ink compositions.

The rapid radiation curable ink compositions of the invention are preferably substantially non-aqueous and/or substantially free of a solvent, that is, a compound having a boiling point at atmospheric pressure of less than about 120° C. As used herein, substantially non-aqueous means that no water is added to the inks other than the incidental amounts of moisture derived from ambient conditions. Non-aqueous inks can therefore have less than about 3 wt. % of water, more specifically less than about 2 wt. % of water, even more specifically less than about 1 wt. % of water, based on the total weight of the respective ink compositions. Substantially free of solvents means no solvent is added to the inks, such that the ink contains less than about 3 wt. % of solvent, more specifically less than about 2 wt. % of solvent, and even more specifically less than about 1 wt. % of solvent, based on the total weight of the respective ink compositions.

The rapid radiation curable ink compositions further comprise a colorant composition comprising a pigment, dye or combination of pigments and dyes to provide the desired color. Combinations of pigments and dye can be used, provided that the thermal stability of the resulting ink is maintained.

Exemplary pigments include those having the following Color Index classifications: Green PG 7 and 36; Orange PO 5, 34, 36, 38, 43, 51, 60, 62, 64, 66, 67 and 73; Red PR 112, 149, 170, 178, 179, 185, 187, 188, 207, 208, 214, 220, 224, 242, 251, 254, 255, 260 and 264; Magenta/Violet PV 19, 23, 31, and 37, and PR 122, 181 and 202; Yellow PY 17, 120, 138, 139, 150, 151, 155, 168, 175, 179, 180, 181 and 185; Blue PB 15, 15:3, 15:4; Black PB 2, 5 and 7; carbon black; titanium dioxide (including rutile and anatase), and the like.

Other specific pigments include, for example, IRGALITE BLUE GLVO, MONASTRAL BLUE FGX, IRGALITE BLUE GLSM, HELIOGEN BLUE L7101F, LUTETIA CYANINE ENJ, HELIOGEN BLUE L6700F, MONASTRAL GNXC, MONASTRAL GBX, MONASTRAL GLX, MONASTRAL 6Y, IRGAZIN DPP ORANGE RA, NOVAPERM ORANGE H5G70, NOVPERM ORANGE HL, MONOLITE ORANGE 2R, NOVAPERM RED HFG, HOSTAPERM ORANGE HGL, PALIOGEN ORANGE L2640, SICOFAST ORANGE 2953, IRGAZIN ORANGE 3GL, CHROMOPTHAL ORANGE GP, HOSTAPERM ORANGE GR, PV CARMINE HF4C, NOVAPERM RED F3RK 70, MONOLITE RED BR, IRGAZIN DPP RUBINE TR, IRGAZIN DPP SCARLET EK, RT-390-D SCARLET, RT-280-D RED, NOVAPERM RED HF4B, NOVAPERM RED HF3S, NOVAPERM RD HF2B, VYNAMON RED 3BFW, CHROMOPTHAL RED G, VYNAMON SCARLET 3Y, PALIOGEN RED L3585, NOVAPERM RED BL, PALIOGEN RED 3880 HD, HOSTAPERM P2GL, HOSTAPERM RED P3GL, HOSTAPERM RED E5B 02, SICOFAST RED L3550, SUNFAST MAGENTA 122, SUNFAST RED 122, CYAN NN-BBD15-1, SUNFAST VIOLET 19 228-0594, SUNFAST VIOLET 19 228-1220, CINQUASIA VIOLET RT-791-D, VIOLET R NRT-201-D, RED B NRT-796-D, VIOLET R RT-101-D, MONOLITE VIOLET 31, SUNFAST MAGENTA 22, MAGENTA RT-243-D, MAGENTA RT 355-D, MAGENTA NN-MCC08-1, RED B RT-195-D, CINQUASIA CARBERNET RT-385-D, MONOLITE VIOLET R, MICROSOL VIOLET R, CHROMOPTHAL VIOLET B, ORACET PINK RF, IRGALITE YELLOW 2GP, IRGALITE YELLOW WGP, PV FAST YELLOW HG, PV FAST YELLOW H3R, HOSTAPERM YELLOW H6G, PV FAST YELLOW, PALIOTOL YELLOW D1155, YELLOW NN-YDF09-1 and IRGAZIN YELLOW 3R. The YELLOW NN-YYP02-1, MAGENTA NN-MCC08-1 and CYAN NN-BBD15-1 are all commercially available from Taiwan Nano.

A number of different carbon black type pigments are commercially available, for example and carbon blacks such as SPECIAL BLACK 100, SPECIAL BLACK 250, SPECIAL BLACK 350, FW1, FW2 FW200, FW18, SPECIAL BLACK 4, NIPEX 150, NIPEX 160, NIPEX 180, SPECIAL BLACK 5, SPECIAL BLACK 6, PRINTEX 80, PRINTEX 90, PRINTEX 140, PRINTEX 150T, PRINTEX 200, PRINTEX U, and PRINTEX V, all available from Degussa, MOGUL L, REGAL 400R, REGAL 330, and MONARCH 900, available from Cabot Chemical Co., MA77, MA7, MA8, MA11, MA100, MA100R, MA100S, MA230, MA220, MA200RB, MA14, #2700B, #2650, #2600, #2450B, #2400B, #2350, #2300, #2200B, #1000, #970, #3030B, and #3230B, all available from Mitsubishi, RAVEN 2500 ULTRA, Carbon black 5250, and Carbon Black 5750 from Columbia Chemical Co.

A number of titanium oxide pigments are also known. Nanostructured titania powders may be obtained, for example, from Nanophase Technologies Corporation, Burr Ridge, Ill., or under the trade names KRONOS® 1171 from Kronos Titan. As will be described in more detail below, titanium dioxide particles are prone to settling, and are therefore often surface treated. The titanium oxide particles can be coated with an oxide, such as alumina or silica, for example. One, two, or more layers of a metal oxide coating may be used, for example a coating of alumina and a coating of silica, in either order. This type of coated titanium oxide is commercially available from E. I. du Pont de Nemours and Company, Wilmington, Del., under the trade name R960. In the alternative, or in addition, the titanium oxide particles may be surface treated with an organic compatibilization agent such as a zirconate, titanate, silanes, silicones, and the like. Surface treatment of titanium dioxide coated with alumina includes, for example, a silicone surface treatment, preferably a dimethicone treatment using dimethicone oil or a stearic acid surface treatment. Stearic acid and alumina coated ultrafine titanium dioxide particles are commercially available, such as UV-Titan M160 from Presperse, Inc., South Plainfield, N.J. Suitable silanes include, for example, trialkoxysilanes, for example 3-(trimethoxysilyl)propyl methacrylate, which is available commercially from Dow Chemical Company, Wilmington, Del. under the trade name Z6030. The corresponding acrylate may also be used. Suitable titanium dioxides may include a decyltrimethoxysilane (DTMS) treated titanium dioxide (40 nanometer average particle diameter) from Tayca Corporation, TD3103 treated titanium dioxide available from Tayca Corporation, the titanium dioxides available from Taiwan Nanoparticle, titanium dioxide particles from NANOTEK or Nanophase Technologies Corporation. Surface-treated titanium oxide hydroxide (TiO(OH)₂) with a 30 nanometer particle size is available as STT100H™ from Titan Kogyo).

Dyes can be employed alone or in combination with one or more pigments to form the colorant composition. Suitable examples of dyes are solvent-soluble dyes such as the ORASOL line available from Ciba Specialty Chemicals or the SAVINYL line available from Clariant. Dyes with reactive hydroxyl groups such as the REACTINT line available from Milliken Chemical are also acceptable.

When pigments are used, they are pre-dispersed prior to incorporation into the respective ink compositions, generally in one or more of the ethylenically unsaturated compounds. For example, the pigment can be dispersed in a multifunctional material such as tripropylene glycol diacrylate, a propoxylated neopentyl glycol diacrylate, a hyperbranched oligomer as described above, and the like. Monofunctional ethylenically unsaturated compounds such as THF acrylate or 2-phenoxyethyl acrylate may also be used in the dispersion vehicle. Other additives may be present to aid in dispersion of the pigments, for example AB-type block copolymers of an alkyl acrylate and a methyl methacrylate. Generally, the pigment comprises about 5 to about 65% of the dispersion.

The pigments generally are of a size that can be jetted from the print head without substantially clogging the print nozzles, capillaries, or other components of the print equipment. Pigment size can also have an effect on the final ink viscosity. The average particle size of the non-white pigments is about 0.1 to about 500 nanometers, specifically less than about 300 nanometers, and more specifically less than about 200 nanometers. For example, the pigments can have a D50 of less than or equal 200 nanometers. White inks based on titanium dioxide pigments can have average pigment particle sizes of up to 400 nm, specifically from 150 to 350 nm, more specifically from 180 to 300 nm.

The ink is not limited to any particular color, but may be formulated to enhance the properties of one. Suitable colors include, for example cyan, magenta, yellow, black, white, orange, green, light cyan, light magenta, violet, and the like. By excluding pigment, a clear ink can also be prepared.

The amount of the colorant composition employed in the respective ink compositions will depend on the choice of pigment and the depth of color desired in the resulting cured material.

In general, the colorant composition is used in an amount of about 0.01 to 25 wt. %, specifically about 0.05 to about 20 wt. %, more specifically about 0.1 to about 20 wt. %, and more specifically about 0.5 to about 15 wt. % of the total weight of the respective ink compositions. An exemplary amount of pigment for cyan, yellow, magenta and black ink compositions is about 3 wt. %, based upon the total weight of the rapid radiation curable ink compositions. An exemplary amount of pigment for white ink compositions is about 12 wt. %, based upon the total weight of the ink composition.

Optionally, the pigment composition can be in the form of a dispersion comprising pigment particles, a radiation curable diluent, and a dispersant to stabilize the dispersed form of the pigment particles. The radiation curable diluent can comprise epoxy groups or ethylenic unsaturation, to provide crosslinking with the ethylenically unsaturated materials of the radiation curable composition. In one embodiment, the diluent can be the same as one or more of the components of the radiation curable composition.

Use of a dispersant improves the stability of the pigment dispersion, and preferably substantially reduces or eliminates agglomeration or settling of the pigment particles during manufacture of the ink, storage, and/or use. The dispersant can be selected from a variety of materials including silicones, and other monomers or oligomers having good wetting properties for the pigment.

The rapid radiation curable ink compositions also contain a photoinitiator composition that comprises a polymerization initiator. The polymerization initiator is selected based on the type of colorant present and the radiation wavelength used to cure the ink. A blend of photoinitiators can be used, having peak energy absorption levels at varying wavelengths within the range of the radiation selected for cure. Preferably, the photoinitiator and photoinitiator blends are sensitive to the wavelengths not absorbed, or only partially affected, by the pigments.

Examples of suitable photoinitiators include 2-benzyl-2-(dimethylamino)-4′-morpholinobutyrophenone; phenylbis (2,4,6-trimethylbenzoyl)-phosphine oxide (bis-acyl phoshine oxide photoinitiator), 2-dimethylamino-2-(4-methyl-benzyl)-1-(4-morpholin-4-yl-phenyl)-butan-1-one photoinitiator, ethyl-2,4,6-timethylbenzoylphenylphosphinate (mono-acyl phoshine oxide photoinitiator), 2-hydroxy-2-methylpropiophenone; trimethylbenzophenone; methylbenzophenone; 2-benzyl-2-(dimethylamino)-4′-morpholinobutyrophenone photoinitiator, 1-hydroxycyclohexylphenyl ketone; 2,2-dimethyl-2-hydroxy-acetophenone; 2,2-dimethoxy-2-phenylacetophenone; 2-methyl-1-[4-(methylthio)phenyl]-2-morpholino-propan-1-one; 2,4,6-trimethylbenzyl-diphenyl-phosphine oxide; benzophenone; bis(2,6-dimethoxybenzoyl)-2,4,4-trimethyl pentyl phosphine oxide; 1-phenyl-2-hydroxy-2-methyl propanone; bis(2,4,6-trimethylbenzoyl)phenylphosphine oxide; camphorquinone; and the like. Combinations comprising one or more the foregoing may also be used. Suitable commercially available photoinitiators include, but are not limited to LUCIRIN TPO, TPO-L, IRGACURE 907, IRGACURE 819, IRGACURE 2959, IRGACURE 184, IRGACURE 369, IRGACURE 379, BENZOPHENONE, SARCURE SR1124 (ITX), DAROCUR 1173, 4265 IRGACURE 651, TZT (SarCure SR1137), and combinations thereof.

The photoinitiator composition is used in amounts effective to initiate polymerization in the presence of the curing radiation, about 4 to about 25 wt. %, specifically about 4.5 to about 20 wt. %, and more specifically about 5 to about 15 wt. %, based on the total weight of the ink. In a particularly preferable embodiment, the ink is a black ink composition, and the photoinitiator is a blend of (A) either 2-benzyl-2-(dimethylamino)-4′-morpholinobutyrophenone, 2-dimethylamino-2-(4-methyl-benzyl)-1-(4-morpholin-4-yl-phenyl)-butan-1-one, or a combination there, in a range of about 4 to about 8 wt. %, and (B) isopropylthioxanthone in a range of about 0.5 to about 3 wt. %, based upon the total weight of the ink. In another particularly preferred embodiment, the ink is a white ink composition, and the photoinitiator is a blend of (A) ESACURE SM 246 in a range of about 2 to about 10 wt. %, based upon the total weight of the ink and (B) isopropylthioxanthone in a range of about 0.1 to about 3 wt. %, based upon the total weight of the ink and (C) Irgacure 819 in a range of about 0.1 to about 3 wt. %, based upon the total weight of the ink.

In one embodiment, in the rapid radiation curable ink compositions it is desirable to use 2-dimethylamino-2-(4-methyl-benzyl)-1-(4-morpholin-4-yl-phenyl)-butan-1-one photoinitiator, phenylbis (2,4,6-trimethylbenzoyl)-phosphine oxide and ethyl-2,4,6-trimethylbenzoylphenylphosphinate in the photoinitiator composition. The 2-dimethylamino-2-(4-methyl-benzyl)-1-(4-morpholin-4-yl-phenyl)-butan-1-one photoinitiator is present in an amount of about 3 to about 8 wt. %, more specifically about 3.2 to about 4 wt. % based upon the total weight of the ink compositions. The phenylbis (2,4,6-trimethylbenzoyl)-phosphine oxide is present in an amount of about 0.5 to about 3 wt. %, more specifically about 1.2 to about 1.8 wt. % based upon the total weight of the rapidly curing ink compositions. The ethyl-2,4,6-trimethylbenzoylphenylphosphinate is present in an amount of about 0.5 to about 5 wt. %, more specifically about 1.7 to about 2.5 wt. % based upon the total weight of the rapidly curing ink compositions.

In another embodiment, in rapid radiation curable ink compositions, it is desirable to use 2-benzyl-2-(dimethylamino)-4′-morpholinobutyrophenone photoinitiator, phenylbis (2,4,6-trimethylbenzoyl)-phosphine oxide and ethyl-2,4,6-trimethylbenzoylphenylphosphinate in the photoinitiator composition. The 2-benzyl-2-(dimethylamino)-4′-morpholinobutyrophenone photoinitiator is present in an amount of about 3 to about 8 wt. %, more specifically about 3.2 to about 4 wt. % based upon the total weight of the ink compositions. The phenylbis (2,4,6-trimethylbenzoyl)-phosphine oxide is present in an amount of about 0.5 to about 3 wt. %, more specifically about 1.2 to about 1.8 wt. % based upon the total weight of the ink compositions. The ethyl-2,4,6-trimethylbenzoylphenylphosphinate is present in an amount of about 0.5 to about 5 wt. %, more specifically about 1.7 to about 2.5 wt. % based upon the total weight of the ink compositions.

The photoinitiator composition can optionally contain a coinitiator or synergist, specifically an amine coinitiator such as, for example, ethyl-4-(dimethylamino)benzoate, 2-ethylhexyl dimethylaminobenzoate, isopropylthioxanthone, 1-chloro-4-propoxythioxanthone and dimethylaminoethyl (meth)acrylate, and the like. Reactive amine coinitiators can be used, such as the commercially available coinitiator CN383, and the like. The coinitiator can be present in the ink in an amount of about 0.1 to about 20 wt. %, specifically about 0.3 to about 10 wt. %, and more specifically about 0.5 to about 5 wt. %, based on the total weight of the rapid radiation curable ink compositions. In one embodiment, the white ink compositions of the invention contains a synergist, which is preferable and amine synergist.

The rapid radiation curable ink compositions can also optionally include, as additives, an ultraviolet light absorbing material (UVA) to act as a sensitizer and/or a hindered light amine stabilizer (HALS) to provide photolytic stability to the ink. The UVA and or HALS can be added to the ink composition to improve the weatherability of the cured ink. These additives provide the retention of color through the lifetime of the cured ink.

Commercial versions of UVAs include, but are not limited to Tinuvin 384-2, Tinuvin 1130, Tinuvin 405, Tinuvin 411L, Tinuvin 171, Tinuvin 400, Tinuvin 928, Tinuvin 99, combinations thereof, and the like. Commercially available examples of HALS include, but are not limited to Tinuvin 123, Tinuvin 292, Tinuvin 144, Tinuvin 152, and the like. There are available as well combinations of UVA and HALS materials, useful in radiation curable inks, and commercially available as Tinuvin 5055, Tinuvin 5050, Tinuvin 5060, Tinuvin 5151. It should be recognized that this list of compounds is exemplary and should not be considered as limited thereto.

Other additives can be included in the radiation curable ink compositions, including stabilizers, antioxidants, leveling agents, and additional dispersion agents. When used, the stabilizers can be present in the ink in an amount of about 0.001 to about 10 wt. %, specifically about 0.01 to about 7 wt. %, and more specifically about 0.1 to about 5 wt. %, based on the total weight of the ink.

Leveling agents can be used to adjust the wetting ability of the inkjet ink, i.e., the ability of the ink to spread uniformly across a. Wetting occurs where the adhesive forces between the inkjet ink and substrate are stronger than the cohesive forces of the ink. Without being bound by theory, it is believed that non-wetting performance, such as beading and contracting, correlates to stronger cohesive forces in the inkjet ink than adhesive forces between the inkjet ink and the substrate. Beading occurs where the inkjet ink, after application, forms a string of disconnected droplets instead of remaining a uniform coat as applied, and contracting occurs where the inkjet ink shrinks from the furthest extent of its initial application to a surface. Specifically useful leveling agents are those that both provide good wetting ability, and in which the surface tension of the inkjet ink is not significantly reduced from the surface tension value prior to addition of the leveling agent.

Leveling agents that do not affect surface tension and are suitable for use herein can be ionic or non-ionic. Specifically useful leveling agents are ionic, where the leveling agent can more be monoionic or polyionic. Polyionic leveling agents can be polymeric, having at least one ionizable site on the polymeric backbone. The ionizable sites on the polymer backbone may be anionic, cationic, or zwitterionic (comprising a combination of both anionic and cationic ionizable sites). Suitable polymeric leveling agents having anionic ionizable sites include poly(meth)acrylates, which may comprise homopolymers or copolymers of methacrylic acid, acrylic acid, maleic acid, fumaric acid, crotonic acid, itaconic acid, or the like, and that are made ionic by treatment with an amine or hydroxide base. Suitable polymeric leveling agents having cationic ionizable sites, include for example, amine substituted poly(meth)acrylates made ionic, which can comprise copolymers of 2-aminoethyl(meth)acrylate, 2-(N,N-dimethylamino)ethyl acrylate, 2-(N,N-dimethylamino)ethyl methacrylate (DMAEMA), and the like, that are subsequently made ionic by treatment with an acid or excess alkylating agent. A suitable zwitterionic poly(meth)acrylate can comprise at least one of each of the anionic and cationic monomers described above. A non-limiting example of a suitable anionic polyacrylate copolymer is BYK 381, available from BYK Chemie USA Inc, which is available as a 52 wt. % solids solution in 2-methoxy methyl ethoxy propanol.

The inkjet recording system for use with the rapid radiation curable ink compositions are not particularly limited, and include, for example, an electric charge controlling system of jetting out the ink by utilizing an electrostatic induction force, a drop-on-demand system (pressure pulse system) utilizing a vibration pressure of a piezoelectric element, an acoustic inkjet system of converting electric signals into acoustic beams, irradiating the beams on the ink and jetting out the ink by utilizing the radiation pressure, and a thermal inkjet (bubble jet) system of heating the ink to form a bubble and utilizing the pressure generated. Impulse printheads, are also known as “drop on demand,” as used herein refers to four types of printheads mentioned above, specifically airbrush, electrostatic, piezoelectric, and thermal. Piezoelectric printheads are available in two classes: binary (on or off) and greyscale (building up a drop's size by adding multiple amounts of smaller drops to it). Impulse printheads are to be distinguished from continuous inkjet printing printheads.

In one embodiment, the rapid radiation curable ink compositions of the invention display a viscosity of about 5 to about 15 centipoise, at a jetting temperature of between about 30 and about 70° C., and a surface tension of between about 20 to about 30 dynes/centimeter. In one embodiment the wet inks will cure to give tack-free, transfer resistant properties using a medium pressure, mercury vapor or iron-doped lamp powered at 300 Watts per inch at 50% operating power at a UV dose about 65 mJ/cm² or less. In another embodiment, the wet white ink compositions of the invention will cure to give tack-free, transfer resistant properties using an iron-doped mercury vapor bulb powered at 300 Watts/inch operating at 50% power at a UV does of about 50 mJ/cm² or less.

The ink compositions described herein are stable enough to be jetted at print speeds of about 8 kHz or greater, more specifically about 10 kHz or greater, yet more specifically about 16 kHz or greater, and still yet more specifically about 32 kHz or greater. Such increased print speeds can be employed without sacrificing print image quality or resolution.

Piezoelectric print heads having print speeds of about 8 kHz or greater can be used, specifically about 10 KHz or greater, specifically about 16 kHz or greater, and yet more specifically about 32 kHz or greater print speed.

The invention is further illustrated by the following non-limiting examples.

### EXAMPLES

The following procedures and techniques employed in the Examples are described below.

Cross Hatch Adhesion: In the cross hatch adhesion test, a substrate was first coated with an ink whose adhesive qualities were to be measured. Films were prepared using a wire round rod and K-Coater proofer at a speed of 4.5, resulting in a thickness of approximately 4 micron. Curing was accomplished using a 300 Watt/inch Hanovia mercury vapor bulb operating at 75% power and a resulting UV dose of 130 mJ/cm². The cured films were conditioned for 16-24 hours at 25° C. (±2° C.), and at a relative humidity of 50% (±5%). A series of 6 parallel incisions of 2 to 2.5 cm in length and spaced 2.0 mm apart was made in the film using a suitable cutting tool such as a Gardco PA-2000 cutting tool with 6 parallel blades, followed by a second set of incisions of the same dimensions and rotated 90° to the first set. In this way a crosshatch pattern was made, and the crosshatched surface was then cleaned using a brush or compressed air to remove particulate contaminants. A length of 7 to 8 cm of a suitable tape, such as 3M 610 tape by 3M Corporation, was applied to the crosshatched area and rubbed smooth against the coated substrate to remove any trapped air bubbles, and to ensure a good contact. The tape was then pulled off within 90 seconds (±30 seconds) upon application at a quick, steady rate as close to 180 degrees as possible. The crosshatch areas were then quantified according to the method of ASTM D 3359 (Test Method B) where 5B refers to the best adhesion and 0B refers to the worst adhesion. In one embodiment, when cured, the ink composition of the invention has an adhesion to rigid or plasticized polyvinyl chloride, PET, PC or ABS of 4B or greater.

MEK rub: The MEK (methyl ethyl ketone) rub technique is a method for assessing the solvent resistance of a cured inkjet ink according to ASTM Method D 5402-93. The ink to be cured was applied to a polyester (PET), polycarbonate (PC), rigid poly(vinylchloride) (PVC), acrylonitrile-butadiene-styrene (ABS) or vinyl substrate, for example Scotchcal 220 vinyl, using #6 Meyer Rod. The coated film was then passed under a 300 Watt/inch Hanovia mercury vapor bulb in order to effect curing (dosage recorded by an International Light IL390C radiometer). Test areas on the ink film surface of at least 2 inches long were selected for testing. The ball end of a hammer wrapped in WYP-ALL wipes was saturated to a dripping wet condition with the MEK. The wet ball end was rubbed across the 2-inch portion of the cured film, one forward and one backward movement constituted a single rub. The surface was rubbed until the ink had been completely removed from any point along the test area or after 100 MEK rubs, whichever came first.

Static and Kinetic COF: The Static and Kinetic coefficient of friction (COF) were determined via Instron. Drawdowns were done using a 12 micron rod on K-coater proofer at a speed of 4.5. The inks were cured over flexible Scotchcal 220 vinyl at 250 mJ/cm², using the Fusion curing unit under the H lamp. The cured films were placed on a horizontal platform and were taped with a scotch tape. With a 100 Newton load cell at 200.7 gram force of a square bar tape with the backside of the vinyl was allowed to slide at a rate of 100 millimeters/minute over a 5 centimeter length. The respective static and kinetic coefficient of friction values were recorded. A blank test involving vinyl substrate was also run as a control. In one embodiment the static COF of the cured ink composition of the invention is less than about 0.7 and the kinetic COF is less than about 0.4.

Ink Transfer Resistance: To examine the resistance of cured films to ink transfer, films of each ink composition were cast onto a polyethylene terephthalate (PET) substrate and films were prepared using a wire wound rod and K-Control Coater apparatus using a coating application speed on the apparatus of 4.5. The resulting films were approximately 4 microns in thickness. The CMYK films were cured using a single 300-Watt/inch Hanovia mercury bulb operating at 50% power. The conveyor speed was 28.2 yards/min (25.8 meters/min). The resulting radiant energy density, or dose as measured via an International Light IL390C radiometer was 65 milliJoules per square centimeter (mJ/cm²) for curing the cyan, magenta, yellow and black inks. The white ink films were cured using a single 300-Watt/inch Hanovia iron-doped bulb operating at 50% power. The conveyor speed was equivalent to that used with the CMYK inks. The resulting radiant energy density, or dose as measured via the IL390C radiometer was 50 mJ/cm².

Immediately after curing, the ink film on the PET substrate was placed face up on the bed of a Little Joe Offset Color Swatching Press (Model S78) and a Leneta opacity chart (Form 2C) was placed face down on top of the ink film. The Little Joe press was run across these opposing substrates one time and the opacity chart was then peeled off the inked PET substrate and cured using a dose of 700 mJ/cm² with the same bulb used to cure the ink films described above. Prior to performing the transfer test, the color coordinates of the clean opacity chart were measured on a DataColor SF600 Plus-CT spectrophotometer using the following settings: Small Area View, Spectral Component Excluded, 10 degree observer. The illuminant used was D65. Saving the clean opacity chart reflectance data as the standard, the same opacity chart after being run through the Little Joe press and post-cured was measured as the batch. The CIE L*a*b* color space Delta E was recorded vs. the standard. For cyan, magenta, yellow and black inks, the white portion of the opacity chart was used to measure the degree of ink transfer. For white inks, the black portion of the chart was used.

The CIE L*a*b* system describes and orders colors based on the opponent theory of color vision. The opponent theory is that colors cannot be perceived as both red and green at the same time, or yellow and blue at the same time. However, colors can be perceived as combinations of: red and yellow, red and blue, green and yellow, and green and blue. In the CIE L*a*b* color space the color coordinates in this rectangular coordinate system are as follows:

L* is the lightness coordinate;

a* is the red/green coordinate, with +a* indicating red, and −a* indicating green; and

b* is the yellow/blue coordinate, with +b* indicating yellow, and −b* indicating blue. CIELAB color difference, between any two colors in CIE 1976 color space, is the distance between the color locations. This distance is typically expressed as ΔE* according to the equation (I) below
(ΔE*)=\sqrt{(ΔL*)²+(Δa*)²+(Δb*)²} (I)
where ΔL* is the lightness difference, Δa* is the red/green difference and Δb* is the yellow/blue difference.

As the color of the Leneta paper may vary due to the age of the UV bulb and a resulting change in intensity, a normalized value for ΔE* (ΔEₙ) is reported for all testing. The normalized value is simply the ΔE* difference recorded after passing through the Little Joe transfer press and post-curing minus the ΔE* value obtained after exposing a blank Leneta chart to the 700 mJ/cm² dose. If the value of ΔEₙ is less than zero, a value of zero is simply reported.

### Example 1

This example compares the curing properties of the rapid radiation curable ink compositions of the invention with comparative commercially available ink compositions. Four comparative compositions and four rapidly curing ink compositions were tested for purposes of this example. The components for the respective compositions are shown in the Table 1.

TABLE 1

| Component | Name |
|---|---|
| BYK 377 | polyether polysiloxane from BYK Chemie |
| SR 238 | hexanediol diacrylate monomer from Sartomer |
| CN 2302 | hyperbranched polyester acrylate oligomer, |
| | average acrylate functionality = 16 from |
| | Sartomer |
| MEHQ | methyl ether of hydroquinone (4-methoxyphenol) |
| | stabilizer from Fisher Scientific |
| IRGANOX | hindered phenol antioxidant from Ciba Specialty |
| 1035 | Chemicals |
| G01-402 | metallic salt stabilizer in tripropyleneglycol |
| | diacrylate from Rahn |
| IRGACURE | 2-dimethylamino-2-(4-methyl-benzyl)-1-(4- |
| 379 | morpholin-4-yl-phenyl)-butan-1-one photoinitiator |
| | from Ciba Specialty Chemicals |
| ITX | isopropylthioxanthone photosynergist from Ciba |
| | Specialty Chemicals |
| IRGACURE | phenyl bis (2,4,6-trimethylbenzoyl)-phosphine |
| 819 | oxide (bis-acyl phoshine oxide photoinitiator) |
| | from Ciba Specialty Chemicals |
| LUCIRIN | ethyl-2,4,6-trimethylbenzoylphenylphosphinate |
| TPO-L | (mono-acyl phoshine oxide photoinitiator) from |
| | BASF |
| V-CAP | n-vinyl 2-caprolactam monomer from BASF or |
| | International Specialty Products |
| IRGACURE | hindered phenol antioxidant from Ciba Specialty |
| 1035 | Chemicals |
| IRGACURE | 2-benzyl-2-(dimethylamino)-4′- |
| 369 | morpholinobutyrophenone photoinitiator from Ciba |
| | Specialty Chemicals |
| HYDROQUINONE | stabilizer from Fisher Scientific |
| CN 2303 | Hyperbranched polyester acrylate oligomer, |
| | average acrylate functionality = 6, from |
| | Sartomer |
| BYK UV3500 | Acrylated polyether polysiloxane from Byk Chemie |
| FLORSTAB | polymerization inhibitor in epoxy and polyester |
| UV-2 | acrylates from Kromachem |
| ESACURE | Blend of 2,4,6-trimethylbenzoyldiphenyl |
| SM 246 | phosphine oxide, 2-hydroxy-2-methyl-1-phenyl |
| | propanone, oligo[2-hydroxy-2-methyl-1[4- |
| | (1-methylvinyl)phenyl] propanone], and |
| | 2-,4-,6-trimethylbenzophenone |

Four compositions, E1-E4, that are representative of the rapid radiation curable ink compositions of the invention as well as four comparative examples C1-C4 are shown in the Table 2. The inks were prepared in four colors notably cyan, magenta, yellow and black. The four comparative compositions do not contain a vinyl amide monomer.

TABLE 2

| | Comparative Examples | | | | Examples of the Invention | | | |
|---|---|---|---|---|---|---|---|---|
| | C1 | C2 | C3 | C4 | E1 | E2 | E3 | E4 |
| Material | (wt. %) | (wt. %) | (wt. %) | (wt. %) | (wt. %) | (wt. %) | (wt. %) | (wt. %) |
| SR256 | 3.420 | 2.300 | 2.310 | 2.310 | | | | |
| CD9087 | | | | 2.310 | | | | |
| Byk UV 3500 | | | | | 0.025 | 0.025 | 0.025 | 0.025 |
| SR238 (HDODA) | 59.320 | 58.900 | 58.430 | 59.379 | 25.080 | 25.080 | 25.080 | 29.000 |
| CN966H90 | 6.500 | 6.000 | 6.500 | 7.500 | | | | |
| CN 2302 | | | | | 30.090 | 30.090 | 30.090 | 30.000 |
| Irgacure 369 | 3.700 | 3.700 | 3.700 | 3.700 | | | | |
| Irgacure 379 | | | | | 3.610 | 3.610 | 3.610 | 3.600 |
| Darocur 1173 | 3.240 | 3.200 | 3.240 | 3.240 | | | | |
| TZT | 2.780 | 2.800 | 2.780 | 2.780 | | | | |
| Irgacure 819 | | | | | 1.530 | 1.530 | 1.530 | 1.525 |
| TPO-L | | | | | 2.000 | 2.000 | 2.000 | 2.000 |
| Hydroquinone | 0.090 | 0.100 | 0.090 | 0.090 | 0.100 | 0.100 | 0.100 | 0.100 |
| Irganox 1035 | 0.930 | 0.000 | 0.930 | 0.930 | 1.000 | 1.000 | 1.000 | 1.000 |
| KS300 | 0.930 | 0.900 | 0.930 | 0.930 | | | | |
| ITX | 0.460 | 0.500 | 0.460 | 0.460 | 1.000 | 1.000 | 1.000 | 1.000 |
| G01-402 | | | 1.000 | 0.500 | 0.500 | 0.500 | 0.500 | 0.500 |
| N-Vinyl Caprolactam | | | | | 16.050 | 16.050 | 16.050 | 16.000 |
| 20% Pigment Blue 15:3 | 15.000 | | | | 15.000 | | | |
| Dispersion in TPGDA | | | | | | | | |
| 20% Pigment Red 122 | | 15.000 | | | | 15.000 | | |
| Dispersion in TPGDA | | | | | | | | |
| 20% Pigment Yellow 180 | | | 15.000 | | | | 15.000 | |
| Dispersion in TPGDA | | | | | | | | |
| 20% Pigment Black 7 | | | | 11.250 | | | | 11.250 |
| Dispersion in TPGDA | | | | | | | | |
| CN386 | 4.630 | 4.600 | 4.630 | 4.630 | 4.010 | 4.010 | 4.010 | 4.000 |
| Florstab UV2 | | 2.000 | | | | | | |
| Totals: | 100.000 | 100.000 | 100.000 | 100.000 | 99.995 | 99.995 | 99.995 | 100.000 |

Two compositions of the rapid radiation curable ink of the invention, E5 and E6, that produced a white color are shown in Table 3.

TABLE 3

| | E5 | E6 |
|---|---|---|
| Material | (wt. %) | (wt. %) |
| CN966H90 | 4.00 | 4.00 |
| MeHQ | 0.05 | 0.05 |
| IRGANOX 1035 | 0.50 | 0.50 |
| IRGANOX 819 | 1.50 | 1.50 |
| DAROCUR 1173 | 5.50 | 5.50 |
| ESACURE ITX | 1.60 | 1.60 |
| DAROCUR TPO | 0.90 | 0.90 |
| IRGACURE 907 | 2.50 | 2.50 |
| CN386 | 4.00 | 4.00 |
| SR238 | 30.00 | 30.00 |
| CN2302 | 10.45 | 15.45 |
| V-CAP | 15.00 | 10.00 |
| white dispersion, 50% TiO₂ blended in | 24.00 | 24.00 |
| SR9003:SR285:CN2302 in a ratio of 59.45:20:20 | | |
| Total | 100.00 | 100.00 |
| Wt. % of TiO₂ pigment contributed by dispersion | 12.00 | 12.00 |
| Wt. % of SR 9003 monomer contributed by dispersion | 7.68 | 7.68 |
| Wt. % of CN 2302 contributed by dispersion | 1.92 | 1.92 |

The comparative compositions and the rapid radiation curable ink compositions of the invention from Table 2 were subjected to a variety of tests to determine their respective properties. Tables 4 and 5 show the ΔE* results for the Examples E1-E4 and the Comparative Examples C1-C4, including a commercially available UV ink set named SOLACHROME CMYK UVR inks which are employed in the MacDermid Colorspan Display Maker 72UVR wide format UV inkjet printer. A white ink SPC-0371W commercially available from Mimaki was also subjected to these measurements.

TABLE 4

| | | | | | Post Cured |
|---|---|---|---|---|---|
| | | | | | Blank Card |
| | C1 | C2 | C3 | C4 | (White Area) |
| ΔE* | 38.83 | 26.60 | 21.60 | 26.77 | 0.59 |
| ΔEₙ | 38.24 | 26.01 | 21.01 | 26.18 | N/A |
| | Solachrome | Solachrome | Solachrome | Solachrome | |
| | UVR Cyan | UVR Magenta | UVR Yellow | UVR Black | |
| ΔE* | 8.18 | 1.85 | 0.88 | 6.20 | 0.59 |
| ΔEₙ | 7.59 | 1.26 | 0.29 | 5.61 | 0.59 |
| | E1 | E2 | E3 | E4 | |
| ΔE* | 0.64 | 0.60 | 0.64 | 0.67 | 0.59 |
| ΔEₙ | 0.05 | 0.01 | 0.05 | 0.08 | N/A |

TABLE 5

| | | | | Post Cured |
|---|---|---|---|---|
| | Mimaki SPC- | | | Blank Card |
| | 0371W | E5 | E6 | (Black Area) |
| ΔE* | 9.32 | 0.12 | 0.04 | 0.18 |
| ΔEₙ | 9.14 | 0 | 0 | N/A |

In the transfer test, a ΔEₙ value of less than or equal to about 0.20 generally indicates a degree of ink transfer that is visually acceptable. Using this criterion, the four colored inks of the invention demonstrate transfer-resistant properties at this low UV dose, whereas the comparative examples all have an undesirably high degree of ink transfer immediately after curing. From the Tables 4 and 5 it may be seen that the rapid radiation curable ink compositions of the invention display a ΔEₙ value for colors evaluated on the white Leneta background of less than 0.20, more specifically less than 0.15. For white rapidly curing ink compositions evaluated on the black Leneta background, the displayed ΔEₙ values are less than 0.30, more specifically less than 0.20.

### Example 2

This example demonstrates the solvent resistant qualities of the rapid radiation curable ink compositions of the invention. The rapidly curing ink compositions advantageously display an increase in solvent resistance over other comparable commercially available compositions. Table 6 shows the results for a methyl ethyl ketone double rub test. For these tests, Comparative Example C4, Example E4 and the Solachrome UVR Black were subjected to methyl ethyl ketone double rub test.

TABLE 6¹

| | | Solachrome UVR | |
|---|---|---|---|
| | C4 | Black | E 4 |
| | Polyethylene Terephthalate (PET) substrate | | |
| MEK Double Rubs | 34 | 0 | >100 |
| | Polycarbonate substrate | | |
| MEK Double Rubs | 57 | 0 | >100 |
| | Plasticized polyvinylchloride (PVC) | | |
| | (Scotchcal 220 vinyl) | | |
| MEK Double Rubs | 4 | 0 | >100 |

¹In Table 6, the inks were cured at a dose of 700 mJ/cm² powered at 100%.

From Tables 6 above and Tables, 7, 8 and 10 below, it is shown that the rapid radiation curable ink compositions of the present invention display equivalent or improved adhesion to multiple plastic substrates, when compared to the commercially available or comparative ink compositions, as well as having a consistent MEK double rub resistance of greater than or equal to about 100 when cured at a doses as low as 130 mJ/cm². The ink compositions exhibit a MEK double rub resistance of greater than or equal to about 100, and preferably greater than or equal to about 40, when cured at a dose of 130 mJ/cm².

### Example 3

Five compositions, E7-E11, that are representative of the rapid radiation curable ink compositions of the invention, containing the vinyl amid monomer, and their properties are shown in the Table 7.

TABLE 7

| | E7 | E8 | E9 | E10 | E11 |
|---|---|---|---|---|---|
| Materials | (Cyan) | (Magenta) | (Yellow) | (Black) | (Yellow) |
| MEHQ | 0.05 | 0.05 | 0.05 | 0.05 | 0.05 |
| Irgacure 379 | 3.60 | 3.60 | 3.60 | 3.60 | 3.60 |
| Irgacure 819 | 1.52 | 1.52 | 1.52 | 1.52 | 1.52 |
| Irganox 1035 | 1.00 | 1.00 | 1.00 | 1.00 | 1.00 |
| ITX | 1.00 | 1.00 | 1.00 | 1.00 | 1.00 |
| Lucirin TPO-L | 2.00 | 2.00 | 2.00 | 2.00 | 2.00 |
| G01-402 | 0.50 | | 0.50 | 0.50 | |
| Byk 377 | 0.25 | 0.25 | 0.25 | 0.25 | 0.15 |
| Florstab UV-2 | | 2.00 | | | |
| SR 238 | 36.58 | 36.58 | 36.58 | 37.83 | 33.68 |
| (HDODA) | | | | | |
| CN 2302 | 22.50 | 21.00 | 22.50 | 25.00 | |
| CN 2303 | | | | | 17.00 |
| Cyan dispersion | 15.00 | | | | |
| 20% pigment blue | | | | | |
| 15:3 in TPGDA | | | | | |
| Magenta | | 15.00 | | | |
| dispersion 20% | | | | | |
| pigment red 122 | | | | | |
| in TPDGA | | | | | |
| Yellow dispersion | | | 15.00 | | 25.00 |
| 20% pigment | | | | | |
| yellow 120 in | | | | | |
| TPGDA | | | | | |
| Black dispersion | | | | 11.25 | |
| 20% pigment | | | | | |
| black 7 in | | | | | |
| TPGDA | | | | | |
| N-Vinyl-2- | 16.00 | 16.00 | 16.00 | 16.00 | 15.00 |
| Caprolactam (V- | | | | | |
| Cap) | | | | | |
| Total | 100.00 | 100.00 | 100.00 | 100.00 | 100.00 |
| Viscosity @ 25° C. | 21.89 | 23.85 | 22.39 | 21.61 | 22.58 |
| (cP) | | | | | |
| Ink Transfer | 0 | 0 | 0 | 0 | 0.11 |
| ΔEₙ | | | | | |
| MEK Double | 40 | 80 | 95 | 47 | >100 |
| Rubs | | | | | |

| | |
|---|---|
| Cure Conditions | Ink Transfer Test: 4-micron films cured @ 65 mJ/cm² using a 300 Watt/inch Hanovia |
| | mercury vapor bulb operating at 50% power. Substrate: PET. MEK Rub Test: 9- |
| | micron films cured @ 130 mJ/cm² using a 300 Watt/inch Hanovia mercury vapor bulb |
| | operating at 75% power. Substrate: rigid PVC |

### Example 4

Six compositions, E12-E17, that are representative of the rapid radiation curable ink compositions of the invention, without the vinyl amide monomer, and their properties are shown in the Table 8. These compositions, without the vinyl amide monomer, exhibit enhanced thermal stability resulting in less than or equal to about 15% viscosity increase measured at 25° C. after aging the inks at 60° C. for 4 weeks.

TABLE 8

| | E12 | E13 | E14 | E15 | E16 | E17 |
|---|---|---|---|---|---|---|
| Materials | (Cyan) | (Magenta) | (Yellow) | (Black) | (Black) | (Black) |
| IRGANOX 1035 | 1.00 | 1.00 | 1.00 | 1.00 | 1.00 | 1.00 |
| IRGACURE 369 | 3.60 | 3.60 | 3.60 | 3.60 | | |
| IRGACURE 379 | | | | | 6.12 | 6.12 |
| ITX | 1.00 | 1.00 | 1.00 | 1.00 | 2.00 | 2.00 |
| IRGACURE 819 | 1.52 | 1.52 | 1.52 | 1.52 | | |
| MEHQ | 0.05 | 0.05 | 0.05 | 0.05 | 0.05 | 0.05 |
| BYK 377 | 0.25 | 0.25 | 0.25 | 0.25 | 0.17 | 1.00 |
| LUCIRIN TPO-L | 2.00 | 2.00 | 2.00 | 2.00 | | |
| G01-402 | 0.50 | 0.50 | 0.50 | 0.50 | | |
| FLORSTAB UV-2 | | 2.00 | | | | |
| CN 2303 | 22.5 | 21.00 | 22.50 | 25.00 | 22.00 | 26.00 |
| SR 238 | 52.58 | 52.08 | 52.58 | 53.83 | 57.41 | 57.88 |
| Cyan dispersion 20% pigment | 15.00 | | | | | |
| blue 15:3 in TPGDA | | | | | | |
| Magenta dispersion 20% pigment | | 15.00 | | | | |
| red 122 in TPDGA | | | | | | |
| Yellow dispersion 20% pigment | | | 15.00 | | | |
| yellow 120 in TPGDA | | | | | | |
| Carbon Black Dispersion 25 wt. % | | | | | | 5.95 |
| in TPGDA | | | | | | |
| Black dispersion 20% pigment | | | | 11.25 | 11.25 | |
| black 7 in TPGDA | | | | | | |
| Viscosity @ 25° C. (cP) | 22.29 | 23.97 | 22.97 | 23.25 | 22.3 | 24.80 |
| Ink Transfer ΔEₙ | 0.11 | 0.11 | 0.06 | 0.12 | 0.11 | 0.02 |
| MEK Double Rubs | >100 | >100 | >100 | 97 | >100 | >100 |

| | |
|---|---|
| Cure Conditions | Ink Transfer Test: 4-micron films cured @ 65 mJ/cm² using a 300 |
| | Watt/inch Hanovia mercury vapor bulb operating at 50% power. |
| | Substrate: PET. MEK Rub Test: 9-micron films cured ® 130 |
| | mJ/cm² using a 300 Watt/inch Hanovia mercury vapor bulb operating |
| | at 75% power. Substrate: rigid PVC |

### Example 5

In this example three compositions, E18-E20, that are representative of the rapid radiation curable ink compositions of the invention as well as seven comparative examples C5-C11, and their properties, are shown in the Table 9.

TABLE 9

| Raw Material | E18 | C5 | C6 | C7 | C8 | C9 | C10 | C11 | E19 | E20 |
|---|---|---|---|---|---|---|---|---|---|---|
| MeHQ | 0.025 | 0.025 | 0.05 | 0.05 | 0.025 | 0.025 | 0.025 | 0.025 | 0.025 | 0.025 |
| Byk 377 | 0.10 | 0.10 | | | 0.10 | 0.10 | 0.10 | 0.10 | | |
| Irganox 1035 | 0.40 | 0.40 | 0.40 | 0.50 | 0.40 | 0.40 | 0.40 | 0.40 | 0.50 | 0.50 |
| ITX | 0.70 | 0.70 | 0.5 | 1.60 | 0.70 | 0.70 | 0.70 | 0.70 | 1.60 | 1.60 |
| Irgacure 184 | | | 3.15 | | | | | | | |
| Darocur 1173 | | | 1.70 | 5.50 | | | | | 5.50 | 5.50 |
| TZT | | | 1.50 | | | | | | | |
| Darocur TPO | | | | 0.90 | | | | | 0.90 | 0.90 |
| Irgacure 907 | | | | 2.50 | | | | | 2.50 | 2.50 |
| Esacure SM246 | 8.00 | 8.00 | | | 8.00 | 8.00 | 8.00 | 8.00 | | |
| VCAP | | | | 16.00 | | 16.00 | | 16.00 | 15.00 | 10.00 |
| Ebecryl 40 | | | 5.00 | | 5.00 | 5.00 | 5.00 | 5.00 | | |
| SR285 | | | 15.00 | | 16.00 | | 16.00 | | | |
| CN 386 | 4.00 | 4.00 | 5.00 | 4.00 | 4.00 | 4.00 | 4.00 | 4.00 | 4.00 | 4.00 |
| Irgacure 819 | 1.50 | 1.50 | 1.00 | 1.50 | 1.50 | 1.50 | 1.50 | 1.50 | 1.50 | 1.50 |
| CN966H90 | | 8.00 | 5.00 | 5.00 | 5.00 | 5.00 | 5.00 | 5.00 | 4.00 | 4.00 |
| SR 238 | 39.275 | 53.275 | 24.70 | 32.45 | 29.275 | 29.275 | 35.275 | 35.275 | 30.00 | 30.00 |
| CN 2302 | 22.00 | | | | | | | | 10.45 | 15.45 |
| white dispersion | | | 37.00 | 30.00 | 30.00 | 30.00 | | | | |
| 1 (40% TiO2 in | | | | | | | | | | |
| SR9003:CN2302 | | | | | | | | | | |
| 70:30) | | | | | | | | | | |
| white dispersion | 24.00 | 24.00 | | | | | 24.00 | 24.00 | | |
| 2 (50% TiO2 in | | | | | | | | | | |
| TPGDA) | | | | | | | | | | |
| white dispersion | | | | | | | | | 24.00 | 24.00 |
| 3 (50% % TiO2 | | | | | | | | | | |
| in SR9003: | | | | | | | | | | |
| SR285:CN2302 | | | | | | | | | | |
| 60:20:20) | | | | | | | | | | |
| Total | 100.00 | 100.00 | 100.00 | 100.00 | 100.00 | 100.00 | 100.00 | 100.00 | 100.00 | 100.00 |
| Wt % TPGDA | 10.08 | 10.08 | | | | | 10.08 | 10.08 | | |
| from dispersion | | | | | | | | | | |
| Wt % SR 9003 | | | 13.5 | 10.92 | 10.92 | 10.92 | | | 6.00 | 6.00 |
| from dispersion | | | | | | | | | | |
| Wt % CN 2302 | | | 5.77 | 4.68 | 4.68 | 4.68 | | | 1.92 | 1.92 |
| from dispersion | | | | | | | | | | |
| Viscosity @ 25° C. | 36.1 | 40.69 | 29.8 | 27.82 | 26.29 | 32.91 | 28.39 | 34.50 | 30.14 | 37.14 |
| (cP) | | | | | | | | | | |
| Ink Transfer ΔEₙ | 0.07 | 1.02 | 5.46 | 1.88 | 6.46 | 1.41 | 3.35 | 0.99 | 0.12 | 0.04 |

### Example 6

The Cross hatch adhesion of Examples E11-17 are presented in Table 10.

TABLE 10
Crosshatch Adhesion of Examples of the Invention to Multiple Substrates

| | E11 | E12 | E13 | E14 | E15 | E17 |
|---|---|---|---|---|---|---|
| Substrate | (Yellow) | (Cyan) | (Magenta) | (Yellow) | (Black) | (Black) |
| Rigid PVC | 5B | 5B | 5B | 5B | 5B | 5B |
| ABS | 5B | 5B | 5B | 5B | 5B | 5B |
| Scotchcal | 5B | 5B | 5B | 5B | 5B | 5B |
| 220 Vinyl | | | | | | |
| PET | 5B | 5B | 5B | 5B | 5B | 5B |
| PC | 5B | 5B | 5B | 5B | 5B | 5B |

| | |
|---|---|
| Conditions | Films were prepared using a wire round rod and K-Coater proofer at a speed |
| | of 4.5, resulting in a thickness of approximately 4 micron. Curing was |
| | accomplished using a 300 W/inch Hanovia mercury vapor bulb operating at |
| | 75% power and a resulting UV dose of 130 mJ/cm² |

### Example 7

The COF for cured inks E12-E14, E21, and C1, C2, C4 and C12 are presented in Table 11. The composition of Example E21 is similar to composition E16, but utilizing 0.25 wt. % of BYK377, 25 wt. % of CN2302 and 54.33 wt. % of SR238. Example C12 is similar to composition C3, but utilizing pigment Yellow 120.

TABLE 11
Cured Ink Coefficient of Friction

| | E12 | E13 | E14 | E21 | C1 | C2 | C12 | C4 | Blank |
|---|---|---|---|---|---|---|---|---|---|
| | (Cyan) | (Magenta) | (Yellow) | (Black) | (Cyan) | (Magenta) | (Yellow) | (Black) | Vinyl |
| Static | 0.3 | 0.4 | 0.4 | 0.4 | 0.8 | 0.7 | 0.9 | 0.9 | 0.7 |
| COF | | | | | | | | | |
| Kinetic | 0.2 | 0.2 | 0.2 | 0.1 | 0.6 | 0.5 | 0.6 | 0.7 | 0.4 |
| COF | | | | | | | | | |

Without wishing to be bound by theory, it is believed that the combination of the highly-functional ethylenically unsaturated hyperbranched oligomer and ethylenically unsaturated difunctional monomer, along with one or more photoinitiators gives the extremely fast physical property development, improved adhesion and solvent resistant characteristics to the rapid radiation curable ink compositions of the invention.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A rapid radiation curable ink composition comprising:
about 1 to about 30 wt. % of an ethylenically unsaturated hyperbranched oligomer having an average functionality of at least 6 per oligomer;
about 15 to about 75 wt. % of a difunctional ethylenically unsaturated compound;
optionally about 0.025 to about 1 wt. % of a surfactant;
about 0.1 to about 25 wt. % of a colorant composition; and
a photoinitiator;
wherein the weight percents are based upon the total weight of the ink composition; and
wherein the ink composition is substantially free of solvent.

2. The ink composition of claim 1, further comprising about 0.1 to about 20 wt. % of a vinyl amide monomer.

3. The ink composition of claim 2, wherein the vinyl amide monomer is N-vinyl pyrrolidone, N-vinyl-2-caprolactam, N-vinyl formamide, N-vinylacetamide, N-vinyl-N-methylacetamide, N-alkyl-N-vinylacetamide or a combination comprising at least one of the foregoing vinyl amide monomers.

4. The ink composition of claim 1, wherein the rapid radiation curable ink composition displays a normalized ΔE* value ΔEₙ after ink transfer testing of less than or equal to about 0.20 at a radiant energy density of about 65 mJ/cm² or less using a mercury vapor bulb with power output of 300 Watts/inch operating at 50% power.

5. The ink composition of claim 1, wherein the rapid radiation curable ink composition displays a normalized ΔE* value ΔEₙ after ink transfer testing of less than or equal to about 0.20 after being cured at a radiant energy density of about 65 mJ/cm or less using a mercury vapor bulb with power output of 300 Watts/inch operating at 50% power and at least 40 MEK double rubs in an MEK rub test at a film thickness of 9 microns on rigid polyvinyl chloride substrate employing a 300 Watt/inch mercury vapor bulb operating at 75% power resulting in a radiant energy density of about 130 mJ/cm² or less, when the test is conducted in accordance with ASTM D5402-93.

6. The ink composition of claim 1, where the ink can be effectively pinned or immobilized to avoid substantial additional droplet spread using a low-power pinning lamp at radiant energy density of less than about 20 mJ/cm² as measured at a distance from the lamp of between 1 and 2 mm.

7. The ink composition of claim 1, wherein the ink contains a monofunctional ethylenically unsaturated monomer in an amount of less than about 10 wt. %, based upon the total weight of the ink composition.

8. The ink composition of claim 1, wherein the viscosity increase is less than or equal to about 15%, when measured at 25° C., after aging the ink composition at 60° C. for 4 weeks.

9. The ink composition of claim 1, having an adhesion to rigid or plasticized polyvinyl chloride, PET, PC or ABS of 4B or greater, when cured at a dose of 130 mJ/cm² utilizing a 300 Watts/inch Hanovia mercury vapor lamp at a thickness of about 4 microns when measured according to ASTM Method D 3359 Test Method B.

10. The ink composition of claim 1, wherein the composition is a cured composition and the cured composition has a static coefficient of friction of less than about 0.7 and a kinetic coefficient of friction of less than about 0.4.

11. The ink composition of claim 1, wherein the composition is a black ink composition, and the photoinitiator is a blend of:
(A) either 2-benzyl-2-(dimethylamino)-4′-morpholinobutyrophenone, 2-dimethylamino-2-(4-methyl-benzyl)-1-(4-morpholin-4-yl-phenyl)-butan-1-one, or a combination thereof, in an amount of between about 4 to about 8 wt. %, based upon the total weight of the ink composition, and
(B) isopropylthioxanthone in a range of about 0.5 to about 3 wt. %, based upon the total weight of the ink composition.

12. The ink composition of claim 1 having a viscosity of less than about 70 cP at 25° C.

13. The ink of claim 1 further comprising a multi-functional thiol component.

14. The ink composition of claim 1, wherein the composition is free of non-hyperbranched ethylenically unsaturated components with a functionality of three or greater.

15. A rapid radiation curable white ink composition comprising:
about 5 to about 25 wt. % of an ethylenically unsaturated hyperbranched oligomer having an average functionality of at least 6 per oligomer;
about 15 to about 80 wt. % of a difunctional ethylenically unsaturated compound;
an amine synergist;
optionally about 0.001 to about 1 wt. % of a surfactant;
about 0.1 to about 25 wt. % of a colorant composition; and
a photoinitiator;
wherein the weight percents are based upon the total weight of the ink composition; and
wherein the ink composition is substantially free of solvent.

16. The white ink composition of claim 15, further comprising about 0.1 to about 20 wt. % of a vinyl amide monomer.

17. The white ink composition of claim 15, wherein the ink composition displays a normalized ΔE* value ΔEₙ after ink transfer testing of less than or equal to about 0.30 at a radiant energy density of about 50 mJ/cm² or less using an iron-doped mercury vapor bulb with power output of 300 Watts/inch operating at 50% power.

18. The white ink composition of claim 15, wherein the concentration of monofunctional ethylenically unsaturated monomer is less than about 10 wt. %, based upon the total weight of the white ink composition.

19. The white ink composition of claim 15, wherein the composition is free of non-hyperbranched ethylenically unsaturated components with a functionality of three or greater.

20. The white ink composition of claim 15, wherein the photoinitiator is a blend of:
(A) ESACURE SM 246 in a range of about 2 to about 10 wt. %, based upon the total weight of the ink,
(B) isopropylthioxanthone in a range of about 0.1 to about 3 wt. %, based upon the total weight of the ink, and
(C) IRGACURE 819 in a range of about 0.1 to about 3 wt. %, based upon the total weight of the ink.

21. A process for preparing a printed article comprising contacting a substrate with the ink composition of claim 1.

22. An article comprising a substrate and the cured ink composition of claim 1.

23. An article comprising a substrate and the cured ink composition of claim 15.
